(19) United States
(12) Patent Application Publication
(10) Pub. No.: US 2022/0194121 A1
(43) Pub. Date: Jun. 23, 2022

(54) A METHOD FOR MANUFACTURING A PRODUCT OF FINE AND DECORATIVE ARTS

(71) Applicants: Oleksandr Olehovych DENYSENKO, Lviv (UA); Oleh Ivanovych DENYSENKO, Lviv (UA)

(72) Inventors: Oleksandr Olehovych DENYSENKO, Lviv (UA); Oleh Ivanovych DENYSENKO, Lviv (UA)

(21) Appl. No.: 17/601,445

(22) PCT Filed: Mar. 27, 2020
(86) PCT No.: PCT/UA2020/000035

§ 371 Date: Oct. 5, 2021

(30) Foreign Application Priority Data
Apr. 19, 2019 (UA) A 2019 04181

(51) Int. Cl. B44C 1/24

(52) U.S. Cl. CPC B44C 1/24

(57) ABSTRACT

The invention relates to the field of fine and decorative arts, in particular, to the artistic and decorative products made in graphic art techniques.

The technical essence of the invention consists in the method for manufacturing a product of fine and decorative arts, according to which a pattern is created, on the basis of the pattern a high-precision matrix with a hollow relief of the pattern is made, the pattern is transferred to the base of the product, wherein according to the invention, a forming element with a pattern relief is made from the high-precision matrix with a hollow relief of the pattern, for this purpose, a layer of anti-adhesive material is applied to the high-precision matrix from the hollow relief side of the pattern and it is allowed to stand until curing, the forming element with the pattern relief is removed from the matrix, after that the pattern is transferred from the forming element to a solid or flexible base of the product, for this purpose, an even ground layer is applied to the base and/or to the forming element from the side of the pattern relief and the forming element is applied with the side having the pattern relief on the product base, and an even ground layer with a hollow relief print of the pattern is formed therebetween and allowed to stand until the ground cures, after which the forming element is removed from the base, and the hollow relief print of the pattern formed in the ground layer on the base is grounded with ink, the remainders of which are removed in the intermediate sections, and it is allowed to stand until the ink dries.

Besides, according to the invention, the layer of anti-adhesive material is applied by using a low molecular weight cold curing silicone compound.

Besides, according to the invention, a ground layer of texture paste based on an aqueous acrylic dispersion is applied to the product base and/or to the forming element.

Besides, according to the invention, after the ink drying, at least one semitransparent glazing ink layer is additionally applied to the ground layer with the pattern.

The proposed method for manufacturing a product of fine and decorative arts allows for enhancing creative and technical ability when creating a product while at the same time upgrading the artistic and aesthetic effect of the product.

### DESCRIPTION OF THE INVENTION

The invention relates to the field of fine and decorative arts, in particular, to the artistic and decorative products made in graphic art techniques.

In the field of printed graphics, methods for manufacturing products of fine and decorative arts (1), (2), (3) are known, among which the closest to the proposed invention in terms of technical essence and a totality of essential features is a method for creating products using the plate-printing technique, for example, calligraphic etching (3), which includes creating a sketch of a pattern, and on its basis, using special tools, drawing the pattern on a copper or zinc plate coated with an acid-resistant varnish, immersing the plate in acid, which etches the metal in the areas free from the varnish, removing the remainder of the varnish from the plate after etching, and, as a result, obtaining a high-precision matrix with a hollow relief of the pattern, filling the hollow relief of the pattern on the plate with a calligraphic etching ink, the remainders of which are wiped off in the intermediate sections, after which the plate is placed on the movable part of a calligraphic etching machine, a sheet of pre-moistened calligraphic etching paper is placed on the plate, covered with felt and rolled through a press shaft so that the ink from the hollow relief of the plate is printed on the paper, after which it is allowed to stand until drying. The main disadvantage of the above method is the use of paper only as a base of the product, which limits the possibility of creating other techniques, and, as a result, other forms of artistic expression.

The object of the invention is to develop a new method for manufacturing products of fine and decorative arts by transferring a pattern created by the graphic art technique to the ground placed on a solid or flexible base, which would enhance creative and technical ability when creating a product while at the same time upgrading the artistic and aesthetic effect of the product.

The problem is solved according to a method for manufacturing a product of fine and decorative arts, according to which a pattern is created, on the basis of the pattern a high-precision matrix with a hollow relief of the pattern is made, the pattern is transferred to the base of the product, wherein according to the invention, a forming element with a pattern relief is made from the high-precision matrix with a hollow relief of the pattern, for this purpose, a layer of anti-adhesive material is applied to the high-precision matrix from the hollow relief side of the pattern and it is allowed to stand until curing, the forming element with the pattern relief is removed from the matrix, after that the pattern is transferred from the forming element to a solid or flexible base of the product, for this purpose, an even ground layer is applied to the base and/or to the forming element from the side of the pattern relief and the forming element is applied with the side having the pattern relief on the product base, and an even ground layer with a hollow relief print of the pattern is formed therebetween and allowed to stand until the ground cures, after which the forming element is removed from the base, and the hollow relief print of the pattern formed in the ground layer on the base is grounded with ink, the remainders of which are removed in the intermediate sections, and it is allowed to stand until the ink dries.

Besides, according to the invention, the layer of anti-adhesive material is applied by using a low molecular weight cold curing silicone compound.

Besides, according to the invention, a ground layer of texture paste based on an aqueous acrylic dispersion is applied to the product base and/or to the forming element.

Besides, according to the invention, after the ink drying, at least one semitransparent glazing ink layer is additionally applied to the ground layer with the pattern.

Manufacturing, based on a pattern, a high-precision matrix with a hollow relief of a pattern, a forming element with a pattern relief and using it for creating a hollow relief print of the pattern on the ground applied to a solid or flexible base, and grounding the hollow relief print of the pattern formed in the ground layer on the base with ink and possibly additionally applying at least one semitransparent glazing ink layer to the ground layer with the pattern has enhanced creative and technical ability when creating a product while at the same time upgrading the artistic and aesthetic effect of the product.

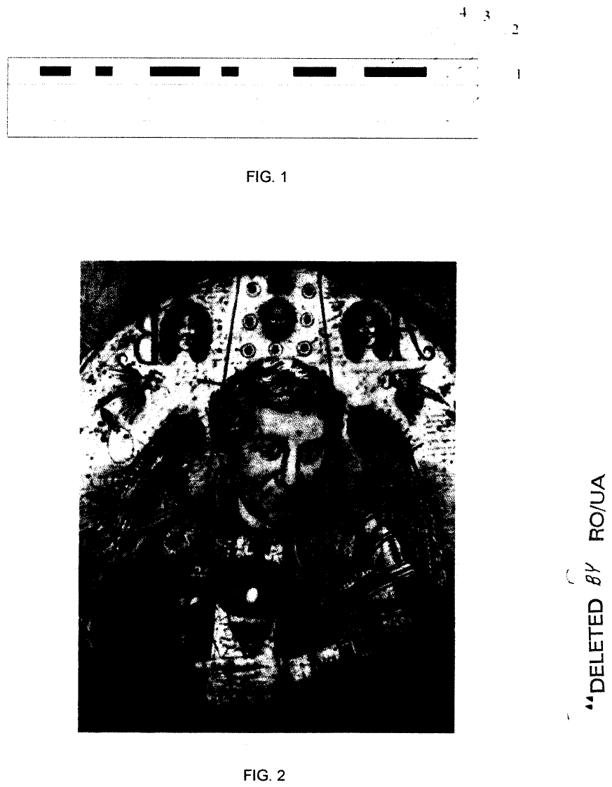

FIG. 1 shows a cross section of a product of fine and decorative arts.

FIG. 2 shows an implementation by the proposed method (graphic image).

The product of fine and decorative arts consists of (FIG. 1) successively arranged heterogeneous layers and includes a base 1, a ground layer 2 placed thereon, an artistic-decorative layer 3 placed in its hollow relief print, at least one glazing layer 4.

The method for manufacturing a product of fine and decorative arts is realized as follows.

When implementing the method, a wide range of materials and technologies can be used.

The pattern can be made by known methods and techniques, in particular: with pencil, pen, by calligraphic etching, plate-printing, engraving, lithography, digital copy and the like. The expression means of the pattern can be lines, strokes, spots and dots, and the like.

A solid or flexible material, such as wood, leather, etc. can be used as a base 1 (FIG. 1).

As a ground 2, a material suitable for the formation of texture and relief can be used, which is initially soft, but it hardens with time and still does not deform, does not crack and does not crumble, forming a stable elastic relief and texture, such as a texture paste based on an aqueous acrylic dispersion, etc. (FIG. 1).

Oil paint and the like can be used as an ink 3 (FIG. 1).

Oil paint and the like can be used as a layer 4 for glazing the image (FIG. 1).

The matrix may be a printing form containing printing and intermediate elements, for example, flexographic, polymetallic, monometallic, offset, calligraphic etching, vitrographic, lithographic, woodcut, or any other.

The forming element can be made of an impression material having high anti-adhesive properties, high elasticity, a high precision of transfer of parts, such as low molecular weight cold curing silicone compounds and the like.

### EXAMPLE 1 OF THE METHOD IMPLEMENTATION

A pattern is scratched using special tools on a copper or zinc plate coated with an acid-repellent varnish. After that, the plate is immersed in acid, which etches the metal in areas free from varnish. After etching, the remainder of the varnish is removed from the plate and a matrix with a hollow relief of the pattern is obtained.

A layer of anti-adhesive material is applied to the matrix from the hollow relief side of the pattern, for example, a low molecular weight cold curing silicone compound which is held until curing, after which it is removed from the matrix, and a forming element with a pattern relief is obtained.

A ground layer, such as a texture paste based on an aqueous acrylic dispersion is applied with a spatula to the base of the product, for example, a wooden board.

A similar ground layer is applied to the forming element from the side of the pattern relief, the forming element is pressed to the base, for example, using a roller, forming an even ground layer therebetween and a hollow relief print of the pattern in it, and it is allowed to stand until the ground cures. After that, the forming element is removed from the base with the ground, and the hollow relief print of the pattern on the base with the ground is grounded with ink, such as oil paint, the remainders of which are removed in the intermediate sections, after which it is allowed to stand until the ink dries, and a product is obtained. If necessary, at least one semitransparent glazing ink layer, such as oil paint, is further applied to the product surface (FIG. 2).

For the replication of the product, this forming element is used, only the base with the ground is changed, and the process is subsequently performed similar to the above.

### EXAMPLE 2 OF THE METHOD IMPLEMENTATION

An image (pattern) is created in a digital medium using a computer graphic editor, such as Photoshop.

Based on the digital image, by means of laser recording of the image on the mask layer (LAMs) a photopolymer printing form is created, in particular, laser recording of the image on the black mask layer of the plate is carried out—a mask is formed; the main exposure to UV radiation is carried out. UV radiation penetrates into the areas exposed after recording the mask and starts the polymerization reaction. The reverse exposure of the plate in UV radiation polymerizes the base or the carrier plate of the printing elements; washing is carried out for removal of unpolymerized areas (water-alkaline solutions, perchlorethylenebutanol or solutions based on alternative solvents can be used as a washing solution). Thermal treatment is an alternative to washing. The plates are dried, the residual stickiness of the plates is removed by being exposed to short-wave radiation of UV-C. If necessary, the plate is further exposed in order to remove the free monomers. A matrix with a hollow relief of the pattern is obtained as a result.

A layer of anti-adhesive material is applied to the matrix from the hollow relief side of the pattern, for example, a low molecular weight cold curing silicone compound which is held until curing, after which it is removed from the matrix, and a forming element with a pattern relief is obtained.

An even ground layer, such as a texture paste based on an aqueous acrylic dispersion is applied with a palette knife to the base of the product, for example, leather.

An even ground layer, the same as the one applied to the base, is applied to the forming element from the side of the pattern relief, for example, using a palette knife, and a forming element is applied with the side having the pattern relief to the ground on the base, and an even ground layer with a hollow relief print of the pattern is formed therebetween, for this, the ground layers between the forming element and the base are rolled, for example with a roller, and allowed to stand until the ground cures. After that, the forming element is removed from the base, and the hollow relief print of the pattern formed in the layer on the base is grounded with ink, such as oil paint, the remainders of which are removed in the intermediate sections, after which it is allowed to stand until the ink dries, and a product is obtained. If necessary, at least one semitransparent glazing ink layer, such as oil paint, is further applied to the product surface (FIG. 2).

For the replication of the product, this forming element is used, only the base with the ground is changed, and the process is subsequently carried out similar to the above.

### REFERENCES

1. Leshchinskiy A. A. Osnovy grafiki: Uchebnoye posobiye (Graphics Basics: Textbook) Grodno: Grodno State University, 2003. Chapter 4. Graphic techniques § 3. Gravure techniques: http://ebooks.grsu.by/leshchinski/technika-glybokoi-pechati.htm.
2. Zahorodniy R. S., Rozum T. V. Suchasni tekhnolohiyi ploskoho ofsetnoho druku zi zvolozhennyam (Modern technologies of photo offset printing with wetting)//Tekhnolohiya I tekhnika drukarstva (Technology and technique of book printing), No 1 (51), 2016. Publishing and Printing Institute affiliated to Ihor Sikorskyy Kyiv Polytechnic Institute.
3. Calligraphic etching (description of the technique). http://eau-forte.blogspot.com/2009/11/blog-post_07.html

1. A method for manufacturing a product of fine and decorative arts, according to which a pattern is created and a high-precision matrix with a hollow relief of the pattern is made, characterized in that a layer of anti-adhesive material is applied to the high-precision matrix from the hollow relief side of the pattern and allowed to stand until curing, the layer of anti-adhesive material is removed from the matrix and a forming element with a relief of the pattern is obtained, an even ground layer is applied to the forming element from the side of the pattern relief and/or to a solid or flexible base of the product, the forming element is applied on the product base, an even ground layer with a hollow relief print of the pattern is formed therebetween and allowed to stand until the ground cures, the base is separated from the forming element, and the hollow relief print of the pattern formed on the base is grounded with ink, the remainders of which are removed in the intermediate sections, and it is allowed to stand until drying.

2. The method for manufacturing a product of fine and decorative arts according to claim 1, characterized in that the anti-adhesive material is a low molecular weight cold curing silicone compound.

3. The method for manufacturing a product of fine and decorative arts according to claim 1, characterized in that the ground is a texture paste based on an aqueous acrylic dispersion.

4. The method for manufacturing a product of fine and decorative arts according to claim 1, characterized in that after the ink drying, at least one glazing ink layer is additionally applied to the ground layer with a pattern.
